(19) United States
(12) Patent Application Publication
(10) Pub. No.: US 2026/0022584 A1
(43) Pub. Date: Jan. 22, 2026

(54) GATE POST

(71) Applicant: LOCINOX, Waregem (BE)

(72) Inventor: Joseph TALPE, Heestert-Zwevegem (BE)

(21) Appl. No.: 19/247,495

(22) Filed: Jun. 24, 2025

(30) Foreign Application Priority Data
Jun. 25, 2024 (EP) 24184245.9

(51) Int. Cl. E04H 17/22

(52) U.S. Cl. CPC E04H 17/22

(57) ABSTRACT

A gate post extending in an upright direction and comprising a bearing frame (10) for supporting a gate. The bearing frame comprises: a gate facing side plate (6) and a free side plate (7) each having a front fastening rib (11) and a back fastening rib (12); and a front plate (8) and a back plate (9) which are fixed to the side plates by means of the fastening ribs. Tor each plate, there exists a plate segment extending in the upright direction uninterruptedly between the bottom end and the top end of the respective plate. This avoids that there are free areas that divide one of the plates into multiple individual elements which could negatively affect the rigidity of the bearing frame.

### TECHNICAL FIELD

The present invention relates to a gate post.

### BACKGROUND ART

In the field of outdoor closure systems there are generally two kinds of gate posts, namely a support gate post on which the closure member is attached and a free gate post against which the closure member closes. In view of their different functions, the gate posts are usually different in size, shape, material, rigidity, etc. In the context of support gate posts, there are various ways on how to mount the closure member to the gate post. This may involve rail assemblies, hinge assemblies, gate closers, gate actuators, etc. Moreover, for each assembly, various kinds exist. For example, hinges may be front mounted, rear mounted, or side mounted. Gate closers may act on the closure member or on the hinge. Due to the various configurations and in order to ensure the required strength, there is usually only limited space for optional components on the support gate post as addressed in EP 1 482 120.

In the context of free gate posts, there is a general desire to incorporate functional components in a modular manner in the gate post. Such functional components include access control means (e.g. keypad, videophone, etc.), postal receiving means (e.g. letter box or packet box), identification information (e.g. resident name, house number, etc.), lighting, etc. Examples of such modular gate posts are disclosed in JP 2001/262962; JP 2005/171660; JP 2006/241877; JP 2008/280755; and JP 2009/094370. A main issue with these kinds of gate posts is that they are not able to support a closure member. Moreover, when a user desires to change the functional components, the entire gate post may be to be revised as there is limited modularity.

JP S60 146198 U discloses a gate post configured to support a closure member in which various functional components are incorporated.

In general, due to the number of possible configurations of closure systems and consumer demands, manufacturers and retailers are required to have a large stock of various gate posts in order to meet consumer needs.

### DISCLOSURE OF THE INVENTION

It is an object of the present invention to provide a gate post which at least partially alleviates one or more of the above-mentioned disadvantages.

The present invention is generally based on the provision of a gate post having a dedicated bearing frame configured to support a gate. The inventors realized that such a bearing frame enables a single gate post design to be used both as a supporting gate post and a free gate post. This firstly provides gate posts that are similar in size, shape, material, etc. This secondly allows to reduce stock as a single bearing frame may be used for both kinds of gate posts.

The present invention is generally aimed at providing a sufficiently strong bearing frame that is both able to bear a gate and that allows mounting a parcel box thereto.

According to the present invention, this is achieved with a gate post extending in an upright direction and comprising a bearing frame configured for supporting a gate, the bearing frame comprising: a gate facing side plate and a free side plate which are mutually parallel and extend in a depth direction between a front edge and a back edge and in the upright direction between a bottom end and a top end, the depth direction being perpendicular to the upright direction, each side plate having an outer face and an inner face, wherein a front fastening rib and a back fastening rib are provided on each inner face; and a front plate and a back plate which are mutually parallel and extend in a width direction between a gate facing edge and a free edge and in the upright direction between a bottom end and a top end, the width direction being perpendicular to both the upright direction and the depth direction, wherein the gate facing edge of the front plate is fixed to the front fastening rib of the gate facing side plate, the gate facing edge of the back plate is fixed to the back fastening rib of the gate facing side plate, the free edge of the front plate is fixed to the front fastening rib of the free side plate, and the free edge of the back plate is fixed to the back fastening rib of the free side plate, and wherein, for each plate, there exists a plate segment extending in the upright direction uninterruptedly between the bottom end and the top end of the respective plate.

As part of the present invention, the inventors realized that a bearing frame assembled from four side plates can undergo sideways slipping in cases where areas of the front and back plate are wholly removed. This is typically done to provide space for a parcel box and results in a bearing frame where the front plate and the back plate both comprise two (or more) individual plates with a free area between them. Even if these individual plates are securely fixed to monolithic side plates, there frequently occurred a sideways slipping of the upper plates with respect to the lower plates. This effect is naturally disadvantageous in case a gate is attached to the bearing frame as the weight of the gate will compound on the sideways slipping potentially leading to a full breakdown of the gate post.

The present invention avoids this sideways slipping problem as each plate (i.e. the front plate, the back plate and both side plates) all exhibit an uninterrupted upright plate segment. The situation where there is thus a free area completely separating one of the plates into individual plates cannot occur in the bearing frame according to the present invention. The sideways slipping problem is thus conveniently avoided.

An embodiment of the present invention is characterised in that each plate is integrally formed, each plate preferably consisting of a unitary piece.

Integrally formed plates improve rigidity and strength as compared to plates formed by fastening various plate elements together, e.g. by bolts, rivets, etc. Unitary pieces further rigidity and strength when compared to integrally formed plates which are achieved by welding several plate elements together. A unitary piece may be achieved by laser cutting the required slits, openings, holes, etc. in a flat metal plate and afterwards folding the desired flanges, angles, corners and the like.

In general, welding operations are preferably avoided for several reasons. Firstly, the welding can damage the finish (e.g. the coating, anodization, surface treatment, etc.) of the metal plates. Secondly, the welding is time consuming and error prone. Thirdly, skilled welders are hard to come by.

An embodiment of the present invention is characterised in that the gate facing side plate and the free side plate are extruded from a metal, preferably aluminium or stainless steel.

Extrusion is a well-known technique to manufacture elongated metal elements. It leads to the formation of unitary pieces and easily allows providing ribs and like structures in the extrusion length direction of the piece.

An embodiment of the present invention is characterised in that the front plate and a back plate are formed by folding a metal, preferably aluminium or stainless steel, plate and, optionally, welding multiple of such folded plates together.

Folding metal plates is also a well-known manufacturing technique. It leads to the formation of unitary pieces and easily allows providing flanges and like structures which are only locally present (i.e. do not extend along the entire length of the piece).

An embodiment of the present invention is characterised in that each fastening rib comprises an upright retention groove configured to retain part of a fastening set used to fix the front and back plate to the side plates and/or in that a plurality of fixation openings are provided near the gate facing edges and near the free edges, which fixation openings are configured to receive a threaded fastening member. The gate post preferably comprises a plurality of threaded sets which are used to fix the front and back plate to the side plates, which threaded fastening set comprises: a threaded fastening member; and a nut member, wherein each threaded fastening member comprises: a head; a shaft extending through a respective fixation opening; and a threaded region on which a respective nut member is mounted, wherein, for each fastening set, one of the head and the nut member is disposed in a respective upright retention groove and the other one of the head and the nut member engages an area surrounding the respective fixation opening.

The use of retention grooves in the side plates and openings in the front/back plates allows to fasten the plates together using commonly available threaded fasteners (e.g. bolts and nuts). One flange like part (i.e. the bolt head or the nut) is retained in the retention groove and the other flange like part engages the plate area surrounding the openings. Tightening the fastening set fixes the side plates together.

An embodiment of the present invention is characterised in that the part of the fastening set retained in the retention groove is provided with a resilient element, e.g. a spring, which engages the retention groove.

This improves manufacturing convenience as the threaded fastening member or the nut member can be placed in the retention groove at the desired height and left there without the need that a person maintains it in the correct position. This resilient element can be formed in a variety of manners, e.g. a spring element, flexible metal lips, a polymeric clip on element, etc.

An embodiment of the present invention is characterised in that the part of the fastening set retained in the retention groove is provided with at least one grip ridge on the side facing the fixation opening, which grip ridge bites into the retention groove when fastening the fastening set.

The biting grip ridges further avoid slipping (e.g. sliding, rotating, etc.) of the fastening set with respect to the fastening rib which may otherwise negatively affect the connection between the plates. It will be appreciated that the fastening set is thus made of a harder material than the side plates.

An embodiment of the present invention is characterised in that the front plate and the back plate are both provided with a substantially rectangular cut-out configured to provide access to a parcel box mounted inside the gate post. Preferably, a lower edge and an upper edge of the substantially rectangular cut-outs are provided with an inwardly extending flange, which flange is configured to mount the parcel box thereto.

Providing the access openings during manufacture of the bearing frame avoids that a mechanic has to create these on site during assembly of the gate post. The flanges further form a convenient way to mount the parcel box to the bearing frame. They further locally improve rigidity of the bearing frame as compared to a non-flanged bearing frame.

An embodiment of the present invention is characterised in that the front plate and a back plate both have an outwardly extending flange at the bottom end, which flange is configured to be fixed to a ground surface. Preferably, a plurality of upright reinforcement ribs are provided interposed between each outwardly extending flange and a respective one of the front and back plate; and/or each outwardly extending flange is provided with a plurality of openings, in particular elongated slots extending in the width direction, configured to receive fixation members to fix the respective one of the front and back plate to the ground surface.

Outwardly extending flanges avoid the need to provide a separate mounting foot for the bearing frame. As they are protruding outwardly, they are easily accessible as well thus improving the ease of installation. The upright reinforcement ribs add to the bearing frame carrying capacity. Advantageously, the reinforcement ribs are bolted to the front and back plate. Bolt openings may be provided during manufacture of the plate (e.g. during the laser cutting). This avoids having to weld these elements, which as described above is disadvantageous. The elongated slots further allow to adjust the gate post in the width direction to better align with an existing closure system.

An embodiment of the present invention is characterised in that the front plate and a back plate both have an outwardly extending flange at the top end, which flange is configured to fix a functional component, for example an electric gate actuator, thereto. Preferably, a support bracket is fixed to both flanges at the top end of the front plate and a back plate, which support bracket is configured to support the electric gate actuator.

The support bracket may have upstanding side edges. The support bracket may have at least one elongated slot extending in the depth direction, which slot is configured to be used in fastening the electric gate actuator. The support bracket may have multiple openings spaced in the width direction, which openings are configured to be used in fastening the electric gate actuator.

The flanges further form a convenient way to mount additional elements (e.g. an electric actuator, hinge elements, a top cover, etc.) to the bearing frame. They further locally improve rigidity of the bearing frame as compared to a non-flanged bearing frame. As they are protruding outwardly, they are easily accessible as well thus improving the ease of installation. The support bracket rigidity is improved by the upstanding side edges. The elongated slot allows to adjust the width position of the electric actuator with respect to the bearing frame to better align with an existing closure system. The plurality of openings allow to align the electric actuator with respect to the bearing frame also in the depth direction.

### BRIEF DESCRIPTION OF THE DRAWINGS

The invention will be further explained by means of the following description and the appended figures.

FIG. 1 shows a closure system comprising a gate post according to the present invention.

FIG. 2 shows a detail of FIG. 1.

FIG. 3 shows the closure system of FIG. 1 in a partly exploded view.

FIG. 4 shows an exploded view of a gate post according to the present invention.

FIG. 5 shows a top view of the connection between a side plate and the front and back plate.

FIGS. 6A and 6B show perspective views of the nut member used in connecting the side plates and the front and back plates.

FIG. 7 shows a top view of an electric actuator mounted on a gate post according to the present invention.

### DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under, left, right, front, back, and the like in the description and the claims are used for descriptive purposes. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

The term “substantially” comprises variations of +/−10% or less, preferably +/−5% or less, more preferably +/−1% or less, and even more preferably +/−0.1% or less, of the specified state, as far as the variations are applicable to function in the present invention. It is to be understood that the term “substantially A” is intended to include “A”.

The invention generally relates to a gate post configured for mounting a closure member and/or various functional components thereon. Such a gate post is commonly used as part of an outdoor closure system.

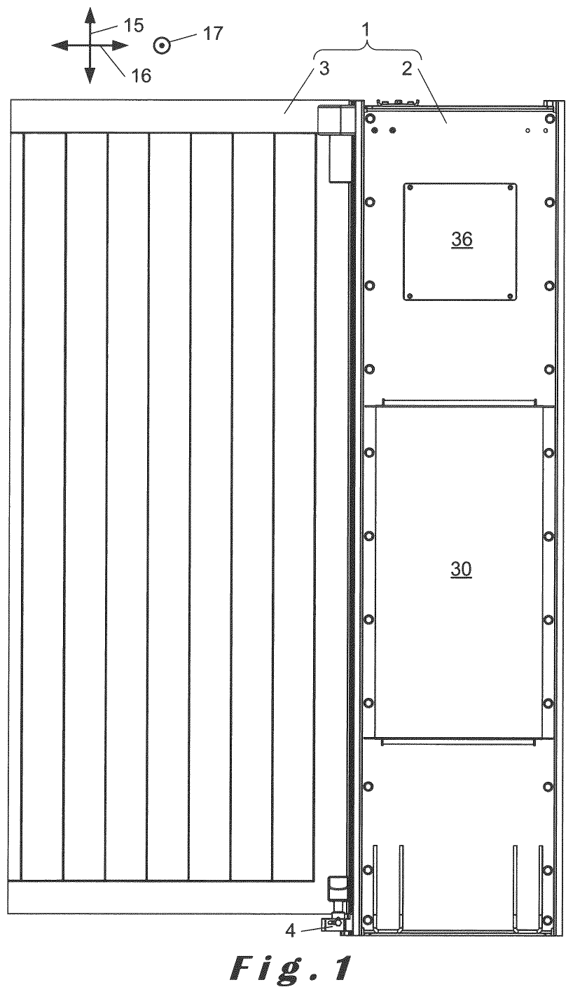

FIG. 1 shows a closure system 1 comprising a support gate post 2 which acts as a support for a moveable, in particular pivotable, closure member 3, such as a gate, a door, or a window. The closure member 3 is connected to the gate post by means of hinges 4. The closure system 1 may further comprise a free gate post (not shown) so that a cooperating lock and keeper assembly may be provided.

The hinges 4 in the closure systems 1 can be any kind of hinges known in the art and may particularly be eyebolt hinges for example as disclosed in EP 1 528 202, EP 2 778 331 or EP 3 162 997 the content of which are incorporated herein by reference. The lock is typically provided on the closure member 3 and may be morticed therein as disclosed in EP 2 186 974, EP 3 153 645, and EP 4 159 962 the content of which are incorporated herein by reference. Alternatively, the lock may be surface mounted on the closure member 3 as disclosed in EP 1 118 739, EP 2 915 939, and EP 4 191 007 the content of which are incorporated herein by reference. The keeper is typically provided on the free gate post. The keeper may be morticed in the free gate post. In an alternative embodiment, the keeper may be surface mounted on the free gate post. Examples of suitable morticed or surface mounted keepers are disclosed in EP 1 600 584, EP 3 109 381, EP 3 153 645, EP 3 239 440, EP 3 421 695, EP 4 159 962, and EP 4 245 951, and unpublished European patent application 23214044.2 the content of which are incorporated herein by reference. Examples of suitable fixture sets for fixing a surface mounted keeper to the free gate post are disclosed in WO 2007/009998 or WO 2019/228896 and unpublished international patent application PCT/EP2023/069721 the content of which are incorporated herein by reference.

The general directions and orientations are also indicated in FIG. 1. More specifically, there is the upright direction 15, the width direction 16 and the depth direction 17 which is perpendicular to the plane of FIG. 1. These three directions 15, 16, 17 are generally substantially perpendicular to one another. The upright direction 15 in practice substantially coincides with the vertical direction. The width and dept directions 16, 17 together form a substantially horizontal plane.

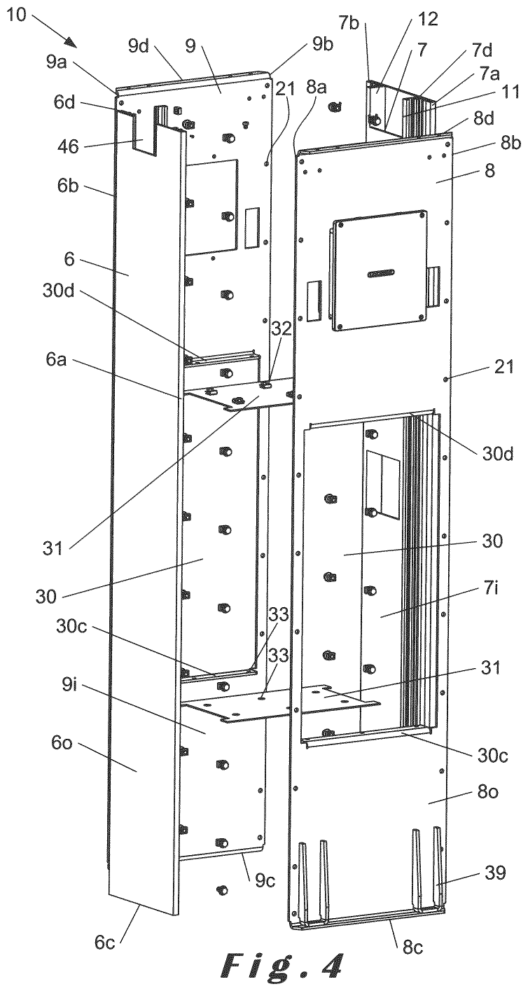

In general, the gate post 2 has four walls which, according to the present invention, are each formed by a single plate. More specifically, as shown in FIG. 4, the gate post has: a gate facing side plate 6 which faces the closure member 3, a free side plate 7 which is opposite the gate facing side plate 6 and which faces away from the closure member 3, a front plate 8 which normally faces outward from the enclosed area, and a back plate 9 which normally faces the enclosed area. Functional components such as access control, dwelling information, resident information, parcel box, etc. are often accessible from the front of the gate post 2 and may also be accessible from the back of the gate post 2.

The gate post according to the present invention may be generally used for both a support gate post and a free gate post and generally comprises a bearing frame 10 acting as a structural component. The bearing frame 10 is formed by joining the plates 6, 7, 8, 9. In practice, the bearing frame 10 will be covered with various covering elements (not shown) to create a desired visual look. The gate post is designed in order to allow various structural (e.g. gate closers, gate actuators, etc.) and/or functional components (e.g. access control, parcel box, etc.) to be mounted thereon and/or integrated therein.

The bearing frame 10 is generally shown in exploded view of FIG. 4 and extends in the upright direction 15. As indicated in FIG. 4, the bearing frame 10 has a gate facing side plate 6, a free side plate 7, a front plate 8, and a back plate 9. The gate facing side plate and the free side plate 6, 7 both extend in the depth direction 17 between a front edge 6a, 7a and a back edge 6b, 7b. Likewise, the front plate and the back plate 8, 9 both extend in the width direction 16 between a gate facing edge 8a, 9a and a free edge 8b, 9b. Each plate 6, 7, 8, 9 extends in the upright direction 15 between a bottom end 6c, 7c, 8c, 9c and a top end 6d, 7d, 8d, 9d. Likewise, each plate 6, 7, 8, 9 has an inner face 6i, 7i, 8i, 9i and an outer face 60, 70, 80, 90. According to the present invention, for each plate, there exists an upright plate segment which runs unbroken (or uninterrupted) from the top end to the bottom end.

The bearing frame 10 is the main structural component of the gate post 2 and as such needs to be able to bear the weight and forces associated with a closure member 3 mounted thereon. In order to achieve the desired strength and rigidity, each plate 6, 7, 8, 9 is generally an integrally formed component. This may be achieved by extruding each plate 6, 7, 8, 9 from a metal, e.g. aluminium or steel. This may also be achieved by hot-rolling or cold-rolling a metal, e.g. steel or aluminium, plate. This may also be achieved by folding a metal, e.g. steel or aluminium, plate. Although each side plate 6, 7, 8, 9 is preferably a unitary (i.e. monolithic) piece, it may also happen that one or more plates are formed by welding separate pieces together. In the illustrated embodiment, the side plates 6, 7 are extruded from a metal, e.g. aluminium or steel, whereas the plates 8, 9 are obtained by folding a metal, e.g. aluminium or steel, plate. The various openings and cut-outs described later may be created by removing excess material (e.g. by laser cutting, milling, etc.). Various thicknesses may be used for the metal of the side plates 6, 7, 8, 9 with suitable values being between 1 mm and 1 cm, for example 2 mm, 3 mm, 4 mm, 5 mm, 6 mm, 7 mm, 8 mm or 9 mm. The thickness depends also on the specific metal used and the manufacturing technique.

The connection between the side plates 6, 7, 8, 9 is described with reference to FIGS. 4 to 6B. To this end, the side plates 6, 7 are provided on their inner face with a front upright connection rib 11 and a back upright connection rib 12. The gate facing edge 8a of the front plate 8 is fixed to the front fastening rib 11 of the gate facing side plate 6, the gate facing edge 9a of the back plate 9 is fixed to the back fastening rib 12 of the gate facing side plate 6, the free edge 8b of the front plate 8 is fixed to the front fastening rib 11 of the free side plate 7, and the free edge 9b of the back plate 9 is fixed to the back fastening rib 12 of the free side plate 7.

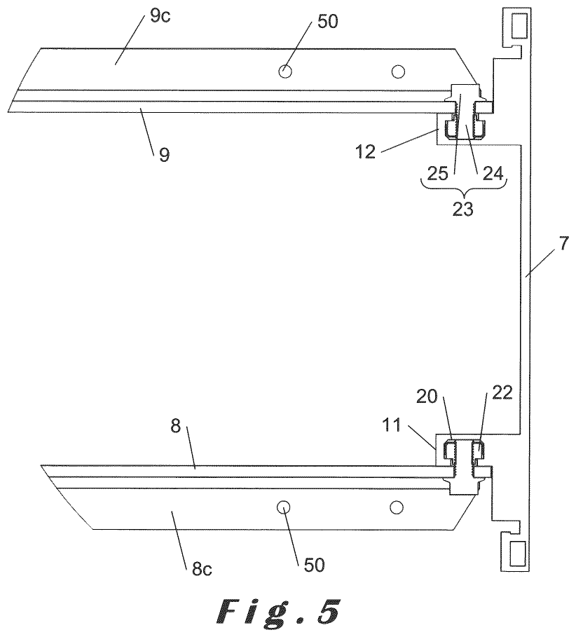

In the illustrated embodiment as shown in FIG. 5, each connection rib 11, 12 is provided with a retention groove 20 extending in the upright direction 15. The retention groove 20 generally has a wide rear portion and a narrow front opening thus preventing a wide element from exiting the front of the retention groove. In FIG. 5, the retention groove 20 is generally T-shaped, but other shapes are possible, e.g. dovetail groove, mushroom groove, etc. The retention grooves 20 are configured to retain nut members 22. The front and back plates 8, 9 have openings 21 on the edges configured to receive threaded fastening members 23 (e.g. bolts). Each threaded fastening member 23 has a threaded shaft 24 engaging the nut member 22 retained in the retention groove 20 and a head 25 engaging the outer face of the front or back plate 8, 9. Fastening the threaded fastening members 23 to the nut members 22 clamps the front and back plates 8, 9 to respective ones of the connection ribs 11, 12 thus forming the bearing frame 10 shown in FIG. 1.

It will be appreciated that the roles of the nut member and the threaded fastening member could be reversed with the nut engaging the outer face of the front or back plate and the head of the threaded fastening member being retained in the retention groove of the connection rib.

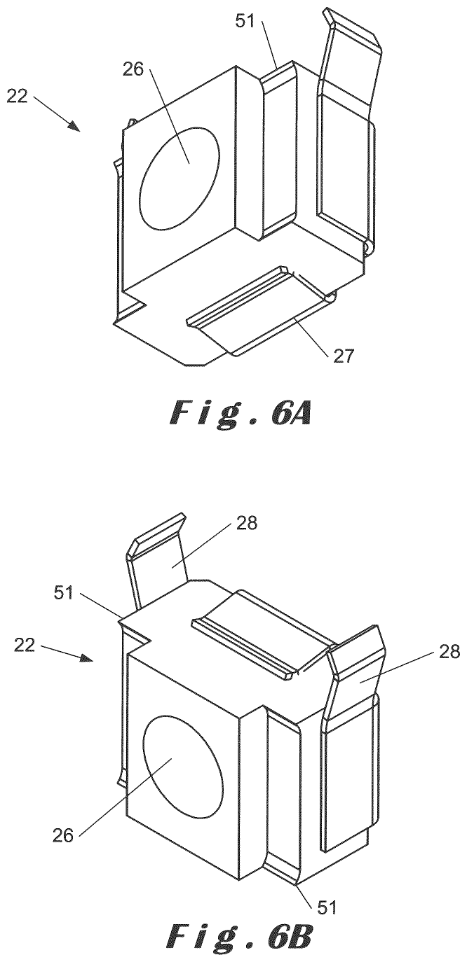

As shown in FIGS. 6A and 6B, each nut member 22 has a through-opening 26 which is provided with an internal thread (not shown) which engages the threaded fastening member 23. A spring clip 27 is placed on the nut member 22, which spring clip 27 has two arms 28. These arms 28 engage the inner walls of the retention groove 20 and exert a force thereon. This force keeps the nut member 22 temporarily locked in the retention groove 20 and prevents that the nut member 22 falls downwards due to gravity. As shown in FIGS. 6A and 6B, the nut member 22 is also provided with several grip ribs 51 on the side facing the fastening ribs 1, 12. These grip ribs 51, when fastening the threaded member 23 bite into the fastening ribs 11, 12 as the nut member 22 is made from a harder material (e.g. stainless steel) than the side plates 8, 9 (e.g. aluminium).

As shown in FIGS. 1 and 4, the front and back plates 8, 9 are both provided with a large rectangular cut-out 30. These cut-outs 30 are provided in order to integrate a parcel box (not shown) in the gate post 2. In order to minimize the loss of rigidity caused by the cut-outs 30, the lower and upper cut-out edges are provided with an inwardly extending flange 30c, 30d. Horizontally extending plate supports 31 are fixed to the flanges 30c, 30d to further improve the rigidity of the bearing frame 10. In the illustrated embodiment, the plate supports 31 are fixed to the flanges 30c, 30d by the provision of openings 3 in both elements through which threaded fastening members (not shown) may extend that grip in clip nuts 32. In the illustrated embodiment, clip nuts 32 are used as disclosed in FIG. 8 of unpublished European patent application 24160956.9 the content of which is incorporated herein by reference.

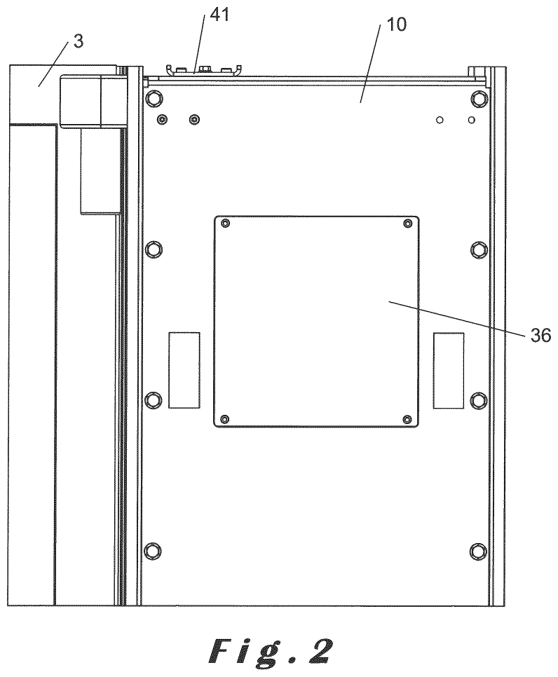

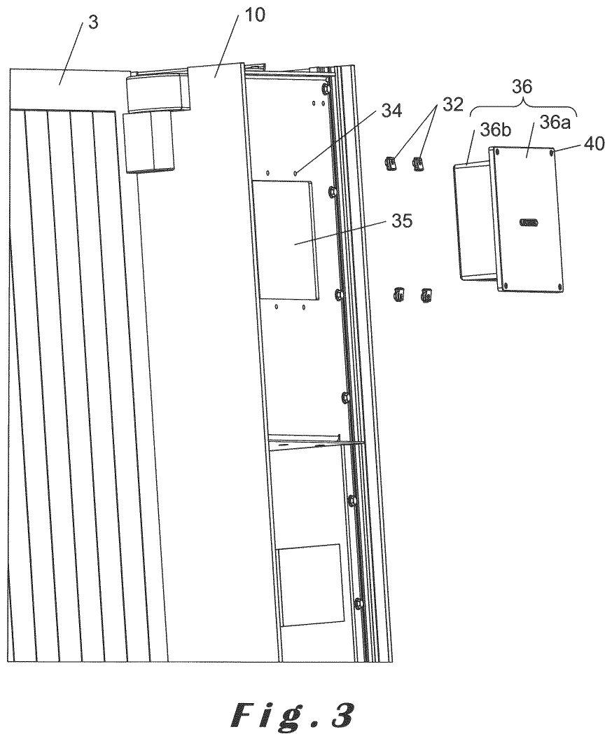

FIGS. 2 and 3 illustrate how an electrical enclosure 36 (which is considered a functional component) may be mounted into the bearing frame 10. To this end, a cut-out 35 is provided in the front plate 8. The electrical enclosure 36 has a base housing 36b to be morticed in the free space 39. Clip nuts 28 are provided in line with the central openings 26 to mount the base housing 36b to the bearing frame 10 by means of threaded fastening members (not shown) engaging in the clip nuts 32 positioned in line with the bolt opening's 34. This ensures that the base housing 36b is securely fixed to the bearing frame 10. Afterwards, a mechanic may install all required electrical connections, circuitry, fuses, etc. needed (naturally depending on the user-selected functionality) in the electrical enclosure. In the framework of an electrical enclosure 36, waterproofing is crucial. The electrical enclosure 36 is sealed by a cover 36a which is attached to the base 36b by means of threaded fasteners 40. In order to reduce the leakage risk, the fasteners 40 are present in each corner of the cover 36a.

In order to connect the bearing frame 10 with the ground surface on which the gate post 2 is mounted, the lower edges 8c, 9c of the front and back plate 8, 9 are provided with an outwardly extending flange. In these flanges openings 50 (see FIG. 5) are provided to fix the bearing frame 10 to the ground surface by means of fastening members. U-shaped reinforcement brackets 39 are added to reinforce the connection between the flanges and the plates 8, 9. Naturally other shaped brackets could be provided.

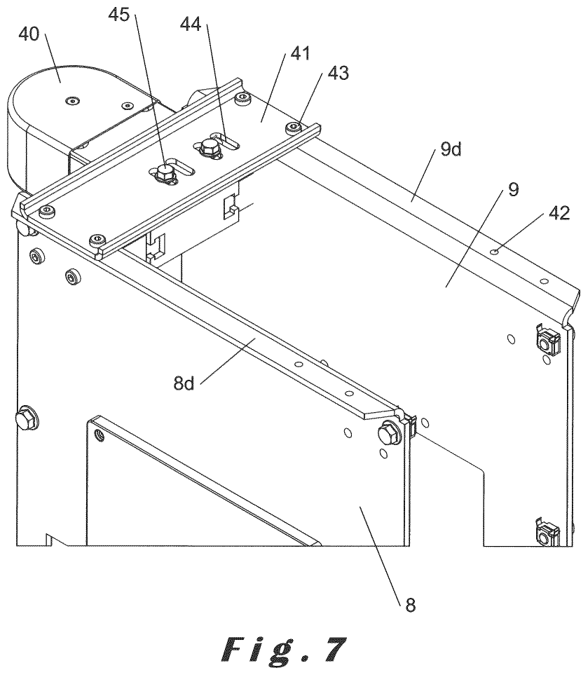

FIG. 7 illustrates how an electric gate actuator 40 may be mounted on the bearing frame 10. It will be appreciated that the actuator could also be non-electric (e.g. spring biased and/or hydraulically damped). To this end, the upper ends of the front and back plate 8, 9 are provided with outwardly extending flanges 8d, 9d in which fixation openings 42 are provided. A U-shaped support bracket 41 is cross-mounted on the flanges 8d, 9d by means of threaded fastening members 43. The upstanding edges of the U-shaped support bracket 41 increase its strength and rigidity. Various elongated slots 44 are provided in the U-shaped support bracket 41 allowing the electric gate actuator 40 to be mounted on the bracket 41 by means of threaded fastening members 45. The elongated slots 44 allow for adjusting the width and/or depth position of the electric gate actuator 40 with respect to the bearing frame 10. As shown in FIG. 4, a free space 46 is provided in the side plates 6, 7 to allow the electric gate actuator 40 to extend therethrough. The support bracket 41 may naturally be used to mount other functional components (e.g. a top cover, hinge parts, etc.) on the bearing frame 10.

Although aspects of the present disclosure have been described with respect to specific embodiments, it will be readily appreciated that these aspects may be implemented in other forms within the scope of the invention as defined by the claims.

1. A gate post extending in an upright direction and comprising a bearing frame configured for supporting a gate, the bearing frame comprising:
a gate facing side plate and a free side plate which are mutually parallel and extend in a depth direction between a front edge and a back edge and in the upright direction between a bottom end and a top end, the depth direction being perpendicular to the upright direction, each side plate having an outer face and an inner face, wherein a front fastening rib and a back fastening rib are provided on each inner face; and
a front plate and a back plate which are mutually parallel and extend in a width direction between a gate facing edge and a free edge and in the upright direction between a bottom end and a top end, the width direction being perpendicular to both the upright direction and the depth direction, wherein:
the gate facing edge of the front plate is fixed to the front fastening rib of the gate facing side plate,
the gate facing edge of the back plate is fixed to the back fastening rib of the gate facing side plate,
the free edge of the front plate is fixed to the front fastening rib of the free side plate, and
the free edge of the back plate is fixed to the back fastening rib of the free side plate, and
wherein, for each plate, there exists a plate segment extending in the upright direction uninterruptedly between the bottom end and the top end of the respective plate, and
wherein each fastening rib comprises an upright retention groove configured to retain part of a fastening set used to fix the front and back plate to the side plates.

2. The gate post according to claim 1, wherein a plurality of fixation openings are provided near the gate facing edges and near the free edges, which fixation openings are configured to receive a threaded fastening member.

3. The gate post according to claim 2, wherein the gate post comprises a plurality of threaded fastening sets which are used to fix the front and back plate to the side plates, which threaded fastening set comprises:
a threaded fastening member; and
a nut member,
wherein each threaded fastening member comprises:
a head;
a shaft extending through a respective fixation opening; and
a threaded region on which a respective nut member is mounted,
wherein, for each fastening set, one of the head and the nut member is disposed in a respective upright retention groove and the other one of the head and the nut member engages an area surrounding the respective fixation opening.

4. The gate post according to claim 3, wherein the part of the fastening set retained in the retention groove is provided with a resilient element, such as a spring, which engages the retention groove.

5. The gate post according to claim 3, wherein the part of the fastening set retained in the retention groove is provided with at least one grip ridge on the side facing the fixation opening, which grip ridge bites into the retention groove when fastening the fastening set.

6. The gate post according to claim 1, wherein each plate is integrally formed.

7. The gate post according to claim 6, wherein the gate facing side plate and the free side plate are extruded from a metal and wherein the front plate and a back plate are formed by folding a metal plate.

8. A gate post extending in an upright direction and comprising a bearing frame configured for supporting a gate, the bearing frame comprising:
a gate facing side plate and a free side plate which are mutually parallel and extend in a depth direction between a front edge and a back edge and in the upright direction between a bottom end and a top end, the depth direction being perpendicular to the upright direction, each side plate having an outer face and an inner face, wherein a front fastening rib and a back fastening rib are provided on each inner face; and
a front plate and a back plate which are mutually parallel and extend in a width direction between a gate facing edge and a free edge and in the upright direction between a bottom end and a top end, the width direction being perpendicular to both the upright direction and the depth direction, wherein:
the gate facing edge of the front plate is fixed to the front fastening rib of the gate facing side plate,
the gate facing edge of the back plate is fixed to the back fastening rib of the gate facing side plate,
the free edge of the front plate is fixed to the front fastening rib of the free side plate, and
the free edge of the back plate is fixed to the back fastening rib of the free side plate, and
wherein, for each plate, there exists a plate segment extending in the upright direction uninterruptedly between the bottom end and the top end of the respective plate, and
wherein the front plate and a back plate both have an outwardly extending flange at the bottom end, which flange is configured to be fixed to a ground surface.

9. The gate post according to claim 8, wherein a plurality of upright reinforcement ribs are provided interposed between each outwardly extending flange and a respective one of the front and back plate.

10. The gate post according to claim 8, wherein each outwardly extending flange is provided with a plurality of openings configured to receive fixation members to fix the respective one of the front and back plate to the ground surface.

11. The gate post according to claim 8, wherein the front plate and the back plate are both provided with a substantially rectangular cut-out configured to provide access to a parcel box mounted inside the gate post.

12. The gate post according to claim 11, wherein a lower edge and an upper edge of the substantially rectangular cut-outs are provided with an inwardly extending flange, which flange is configured to mount the parcel box thereto.

13. The gate post according to claim 8, wherein each plate is integrally formed.

14. The gate post according to claim 13, wherein the gate facing side plate and the free side plate are extruded from a metal and wherein the front plate and a back plate are formed by folding a metal plate.

15. A gate post extending in an upright direction and comprising a bearing frame configured for supporting a gate, the bearing frame comprising:
a gate facing side plate and a free side plate which are mutually parallel and extend in a depth direction between a front edge and a back edge and in the upright direction between a bottom end and a top end, the depth direction being perpendicular to the upright direction, each side plate having an outer face and an inner face, wherein a front fastening rib and a back fastening rib are provided on each inner face; and
a front plate and a back plate which are mutually parallel and extend in a width direction between a gate facing edge and a free edge and in the upright direction between a bottom end and a top end, the width direction being perpendicular to both the upright direction and the depth direction, wherein:
the gate facing edge of the front plate is fixed to the front fastening rib of the gate facing side plate,
the gate facing edge of the back plate is fixed to the back fastening rib of the gate facing side plate,
the free edge of the front plate is fixed to the front fastening rib of the free side plate, and
the free edge of the back plate is fixed to the back fastening rib of the free side plate, and
wherein, for each plate, there exists a plate segment extending in the upright direction uninterruptedly between the bottom end and the top end of the respective plate, and
wherein the front plate and a back plate both have an outwardly extending flange at the top end, which flange is configured to fix a functional component thereto.

16. The gate post according to claim 15, wherein the functional component comprises an electric gate actuator.

17. The gate post according to claim 16, wherein a support bracket is fixed to both flanges at the top end of the front plate and a back plate, which support bracket is configured to support the electric gate actuator.

18. The gate post according to claim 17, wherein the support bracket has upstanding side edges.

19. The gate post according to claim 17, wherein the support bracket has at least one elongated slot extending in the depth direction, which slot is configured to be used in fastening the electric gate actuator.

20. The gate post according to claim 17, wherein the support bracket has multiple openings spaced in the width direction, which openings are configured to be used in fastening the electric gate actuator.
